(19) United States
(12) Patent Application Publication
(10) Pub. No.: US 2019/0095976 A1
(43) Pub. Date: Mar. 28, 2019

(54) COMPETITIVE SHOPPING PLATFORM

(71) Applicant: Brett Stubbs, Lehi, UT (US)

(72) Inventor: Brett Stubbs, Lehi, UT (US)

(21) Appl. No.: 16/129,387

(22) Filed: Sep. 12, 2018

Related U.S. Application Data
(60) Provisional application No. 62/562,240, filed on Sep. 22, 2017.

(51) Int. Cl. G06Q 30/06; G06F 17/30; G06F 17/27; G06Q 50/00

(52) U.S. Cl. CPC G06Q 30/0631; G06F 17/30867; G06Q 50/01; G06F 17/30876; G06F 17/2705

(57) ABSTRACT

Apparatuses, methods, systems, and program products are disclosed for a competitive shopping platform. A method includes receiving, at an online sales platform, one or more comments associated with a social media post on a social media platform. The method includes parsing, for each user associated with each of the one or more comments, the one or more comments to identify commands for purchasing products presented in the social media post. The method includes automatically, for each of the one or more users, populating an online shopping cart at the online sales platform with one or more products identified in the comments for purchasing products.

### CROSS-REFERENCES TO RELATED APPLICATIONS

This application claims the benefit of U.S. Provisional Patent Application No. 62/562,240 entitled “COMPETITIVE SHOPPING PLATFORM” and filed on Sep. 22, 2017, for Brett Stubbs, which is incorporated herein by reference.

### FIELD

This invention relates to social networking technology and more particularly relates to a social media competitive shopping platform.

### BACKGROUND

Users on social media networks can post a variety of content, including posts advertising products for sale, businesses, services, etc. Conventionally, if a user wants to purchase a product that is advertised on social media, the user has to go through a number of manual steps to connect with the seller and share sensitive financial and personal information with the seller to finalize the transaction. The process can be frustrating, time consuming, error prone, and creates opportunities for sensitive information to be misappropriated.

### SUMMARY

A method for a competitive shopping platform is disclosed. An apparatus and program product also perform the functions of the method. In one embodiment, a method includes receiving, at an online sales platform, one or more comments associated with a social media post on a social media platform. In certain embodiments, the social media post is associated with a sale hosted on the online sales platform. The method, in further embodiments, includes parsing, for each user associated with each of the one or more comments, the one or more comments to identify commands for purchasing products presented in the social media post. The method, in various embodiments, includes automatically, for each of the one or more users, populating an online shopping cart at the online sales platform with one or more products identified in the comments for purchasing products.

In one embodiment, an apparatus includes a processor and a memory that stores code executable by the processor to receive, at an online sales platform, one or more comments associated with a social media post on a social media platform. In certain embodiments, the social media post is associated with a sale hosted on the online sales platform. The apparatus, in further embodiments, includes code executable by the processor to parse, for each user associated with each of the one or more comments, the one or more comments to identify commands for purchasing products presented in the social media post. The apparatus, in various embodiments, includes code executable by the processor to automatically, for each of the one or more users, populate an online shopping cart at the online sales platform with one or more products identified in the comments for purchasing products.

A program product, in one embodiment, includes a computer readable storage medium that stores code executable by a processor. In one embodiment, the executable code includes code to perform receiving, at an online sales platform, one or more comments associated with a social media post on a social media platform. In certain embodiments, the social media post is associated with a sale hosted on the online sales platform. The executable code includes code to perform, in further embodiments, parsing, for each user associated with each of the one or more comments, the one or more comments to identify commands for purchasing products presented in the social media post. The executable code includes code to perform, in various embodiments, automatically, for each of the one or more users, populating an online shopping cart at the online sales platform with one or more products identified in the comments for purchasing products.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a schematic block diagram illustrating one embodiment of a system for a competitive shopping platform in accordance with one embodiment of the subject matter disclosed herein;

FIG. 1B is a schematic block diagram illustrating one embodiment of a competitive shopping platform in accordance with one embodiment of the subject matter disclosed herein;

FIG. 2 is a schematic block diagram illustrating one embodiment of an apparatus for a competitive shopping platform in accordance with one embodiment of the subject matter disclosed herein;

FIG. 3 is a schematic block diagram illustrating one embodiment of another apparatus for a competitive shopping platform in accordance with one embodiment of the subject matter disclosed herein;

FIG. 4 is a schematic block diagram illustrating one embodiment of a social media interface for a competitive shopping platform in accordance with one embodiment of the subject matter disclosed herein;

FIG. 5 is a schematic flow chart diagram illustrating one embodiment of a method for a competitive shopping platform in accordance with one embodiment of the subject matter disclosed herein; and

FIG. 6 is a schematic flow chart diagram illustrating one embodiment of another method for a competitive shopping platform in accordance with one embodiment of the subject matter disclosed herein.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

A method for a competitive shopping platform is disclosed. An apparatus and program product also perform the functions of the method. In one embodiment, a method includes receiving, at an online sales platform, one or more comments associated with a social media post on a social media platform. In certain embodiments, the social media post is associated with a sale hosted on the online sales platform. The method, in further embodiments, includes parsing, for each user associated with each of the one or more comments, the one or more comments to identify commands for purchasing products presented in the social media post. The method, in various embodiments, includes automatically, for each of the one or more users, populating an online shopping cart at the online sales platform with one or more products identified in the comments for purchasing products.

In one embodiment, the method includes queuing the purchase commands for one or more products presented in the social media post. The purchase commands may be added to queues associated with each of the one or more products presented in the social media post based on the products identified in each of the commands.

In various embodiments, the method includes, for each user, generating a link to the user's online shopping cart associated with the sale, receiving the user's social media credentials at the online sales platform responsive to the user clicking the link, generating a token based on a sale identifier and the user's social media credentials, checking the queue for the user's comments identified by the token, and adding the products identified in the user's comments in the queue to the online shopping cart.

In one embodiment, a product is added to the user's online shopping cart in response to determining that the position of the token in the queue is equal to or less than a quantity associated with the product. In certain embodiments, the method includes linking the social media post to the sale hosted on the online sales platform. In one embodiment, the online sales platform generates the online shopping carts for each user associated with the sale. In some embodiments, the social media post is linked to the sale hosted on the online sales platform by associating an identifier for the social media post with an identifier for the sale.

In one embodiment, the online sales platform receives the one or more comments associated with the social media post in real-time. In some embodiments, the online sales platform receives the one or more comments associated with the social media post at periodic intervals. In various embodiments, the sale is active on the online sales platform for a predetermined period of time. In further embodiments, the shopping cart for each user is populated with the one or more products after expiration of the predetermined period of time. In certain embodiments, the shopping cart for each user is populated with the one or more products in a same order as the one or more comments are received.

In one embodiment, the sale comprises an auction such that the shopping cart for each user is populated with the one or more products in an order determined based on one or more bids received for each product presented in the social media post. In further embodiments, the method includes parsing the one or more comments for one or more predefined commands followed directly by an identifier for a product presented in the social media post. In some embodiments, the one or more comments comprise administrative commands that are used to update the sale hosted on the online sales platform during the sale.

In one embodiment, an apparatus includes a processor and a memory that stores code executable by the processor to receive, at an online sales platform, one or more comments associated with a social media post on a social media platform. In certain embodiments, the social media post is associated with a sale hosted on the online sales platform. The apparatus, in further embodiments, includes code executable by the processor to parse, for each user associated with each of the one or more comments, the one or more comments to identify commands for purchasing products presented in the social media post. The apparatus, in various embodiments, includes code executable by the processor to automatically, for each of the one or more users, populate an online shopping cart at the online sales platform with one or more products identified in the comments for purchasing products.

In one embodiment, the code is further executable by the processor to queue the purchase commands for one or more products presented in the social media post. Purchase commands may be added to queues associated with each of the one or more products presented in the social media post based on the products identified in each of the commands.

In some embodiments, the code is further executable by the processor to, for each user, generate a link to the user's online shopping cart associated with the sale, receive the user's social media credentials at the online sales platform responsive to the user clicking the link, generate a token based on a sale identifier and the user's social media credentials, check the queue for the user's comments identified by the token, and add the products identified in the user's comments in the queue to the online shopping cart.

In one embodiment, a product is added to the user's online shopping cart in response to determining that the position of the token in the queue is equal to or less than a quantity associated with the product. In certain embodiments, the code is further executable by the processor to link the social media post to the sale hosted on the online sales platform. In some embodiments, the online sales platform generates the online shopping carts for each user associated with the sale.

A program product, in one embodiment, includes a computer readable storage medium that stores code executable by a processor. In one embodiment, the executable code includes code to perform receiving, at an online sales platform, one or more comments associated with a social media post on a social media platform. In certain embodiments, the social media post is associated with a sale hosted on the online sales platform. The executable code includes code to perform, in further embodiments, parsing, for each user associated with each of the one or more comments, the one or more comments to identify commands for purchasing products presented in the social media post. The executable code includes code to perform, in various embodiments, automatically, for each of the one or more users, populating an online shopping cart at the online sales platform with one or more products identified in the comments for purchasing products.

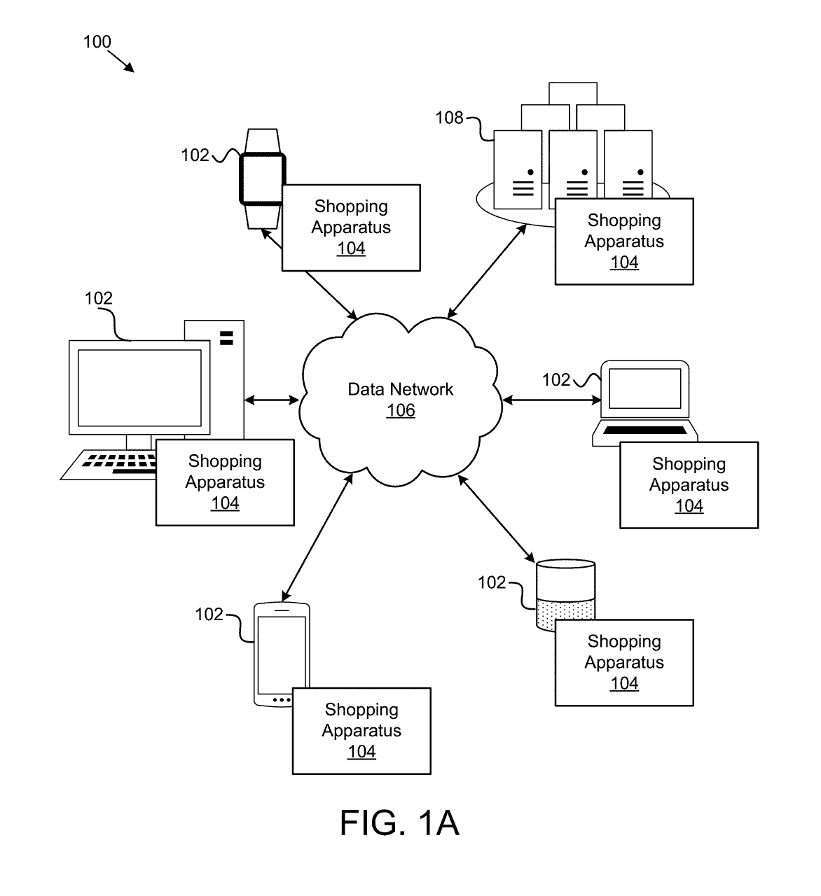

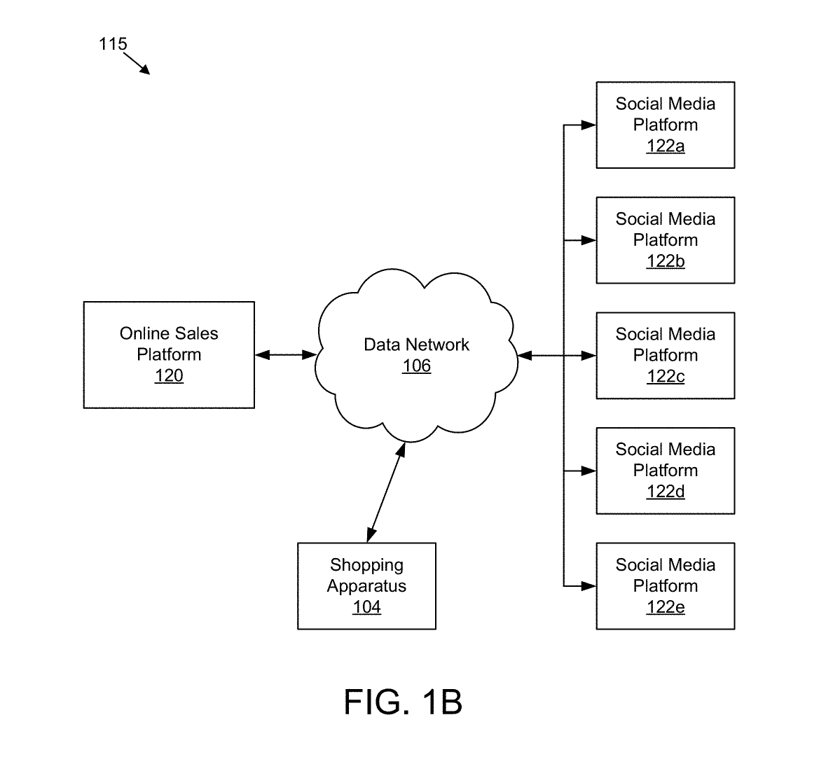

FIG. 1A is a schematic block diagram illustrating one embodiment of a system 100 for a competitive shopping platform. In one embodiment, the system 100 includes one or more information handling devices 102, one or more shopping apparatuses 104, one or more data networks 106, and one or more servers 108. In certain embodiments, even though a specific number of information handling devices 102, shopping apparatuses 104, data networks 106, and servers 108 are depicted in FIG. 1, one of skill in the art will recognize, in light of this disclosure, that any number of information handling devices 102, shopping apparatuses 104, data networks 106, and servers 108 may be included in the system 100.

In one embodiment, the system 100 includes one or more information handling devices 102. The information handling devices 102 may include one or more of a desktop computer, a laptop computer, a tablet computer, a smart phone, a smart speaker (e.g., Amazon Echo®, Google Home®, Apple HomePod®), a security system, a set-top box, a gaming console, a smart TV, a smart watch, a fitness band or other wearable activity tracking device, an optical head-mounted display (e.g., a virtual reality headset, smart glasses, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium.

In certain embodiments, the information handling devices 102 are communicatively coupled to one or more other information handling devices 102 and/or to one or more servers 108 over a data network 106, described below. The information handling devices 102, in a further embodiment, may include processors, processor cores, and/or the like that are configured to execute various programs, program code, applications, instructions, functions, and/or the like. The information handling devices 102 may include executable code, functions, instructions, operating systems, and/or the like for facilitating social shopping transactions, as described in more detail below.

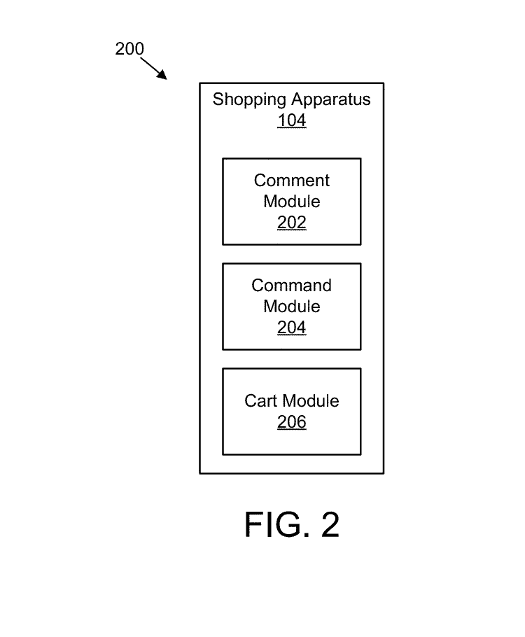

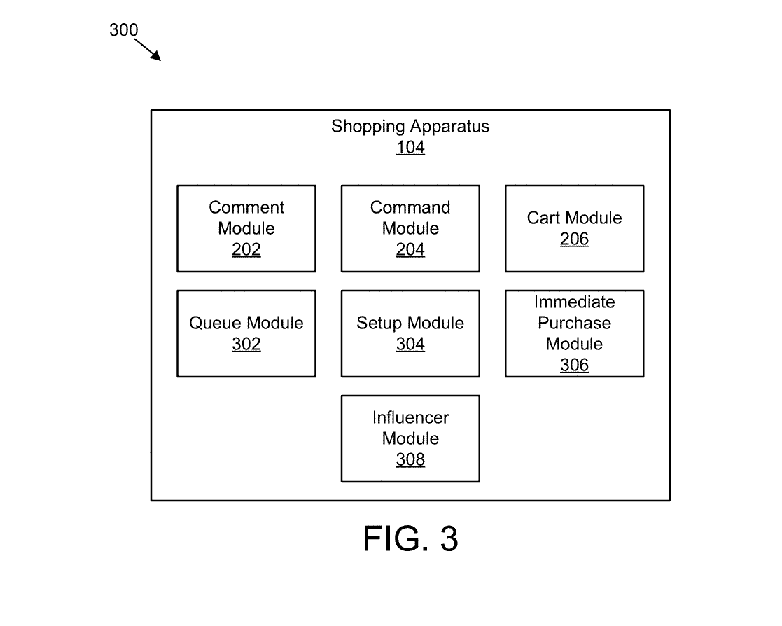

In one embodiment, the shopping apparatus 104 is configured to receive, at an online sales platform, one or more comments associated with a social media post on a social media platform. The social media post may be associated with a sale hosted on the online sales platform. In further embodiments, the shopping apparatus 104 is configured to parse one or more comments for commands for purchasing products presented in the social media post for each of one or more users that are associated with the one or more comments. The shopping apparatus 104, in certain embodiments, automatically populates an online shopping cart at the online sales platform with one or more products identified in the commands for purchasing products for each of the one or more users. The shopping apparatus 104, including its various sub-modules, may be located on one or more information handling devices 102 in the system 100, one or more servers 108, one or more network devices, and/or the like. The shopping apparatus 104 is described in more detail below with reference to FIGS. 2 and 3.

In one embodiment, the shopping apparatus 104 provides a solution over conventional online shopping systems in that it provides a seamless approach for social media users to purchase products from within the social media platform. For example, a Facebook® user may begin a live video for presenting products that Facebook® users can purchase. Conventionally, to indicate their intention to purchase a presented product, social media users would either post a comment stating that they are interested in product A, product B, and so on, or they could direct message the video host to let the video host know which products they are interested in. The video host may then reach out to each of the users that showed interest in a product after the live video is done, confirm that each user is still interested in the products, coordinate payment and shipping, create an invoice for each user, and prepare and ship the products, all of which requires the user to perform a series of manual steps that takes time, creates opportunities for errors (e.g., errors in receiving address information, purchasing information from the user such as quantity, sizes, colors, etc., and/or the like), and requires a number of communications between the video host and the purchaser to collect the purchaser's information such as shipping information, payment information, and/or the like. It also requires the purchaser to provide their sensitive financial payment information to the video host in an unencrypted or otherwise insecure manner.

Unlike conventional systems, the shopping apparatus 104 automatically parses the comments associated with the social media post, e.g., the live video on Facebook®, for predefined commands for purchasing products presented in the live video, and automatically populates an online shopping cart that the user uses to checkout and pay for the products. The purchaser's shipping information is further provided automatically to the host of the social media post, and payment can be made through the online shopping cart in an encrypted or otherwise secure manner so that the purchaser's financial information is not available in the open. Thus, the shopping apparatus 104 provides a seamless way to complete transactions via a social media platform without requiring much, if any, interaction between the host of the social media post and the commenters/shoppers/purchasers.

In certain embodiments, the shopping apparatus 104 parses the comments for other types of commands such as commands for preordering products, for watching or following the social media post for the sale, for bidding on products, for reserving or holding products, for getting alerts about a product or a sale, for creating product entries, for making donations, and/or the like.

In various embodiments, the shopping apparatus 104 may be embodied as a hardware appliance that can be installed or deployed on an information handling device 102, on a server 108, or elsewhere on the data network 106. In certain embodiments, the shopping apparatus 104 may include a hardware device such as a secure hardware dongle or other hardware appliance device (e.g., a set-top box, a network appliance, or the like) that attaches to a device such as a laptop computer, a server 108, a tablet computer, a smart phone, a security system, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the shopping apparatus 104 may include a power interface, a wired and/or wireless network interface, a graphical interface that attaches to a display, and/or a semiconductor integrated circuit device as described below, configured to perform the functions described herein with regard to the shopping apparatus 104.

The shopping apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the shopping apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the shopping apparatus 104.

The semiconductor integrated circuit device or other hardware appliance of the shopping apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the shopping apparatus 104 includes and/or is communicatively coupled to one or more non-volatile memory media, which may include but is not limited to: NAND flash memory, NOR flash memory, nano random access memory (nano RAM or NRAM), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (LAN), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102. The shopping apparatus 104, or a portion of the shopping apparatus 104, may be stored on the one or more servers 108, one or more information handling devices 102, and/or the like. For instance, a server 108 may comprise an online shopping platform that uses the shopping apparatus 104 to receive and parse social media comments, as described in more detail below.

FIG. 1B depicts one embodiment of a competitive shopping platform 115. In one embodiment, the competitive shopping platform 115 includes an online sales platform 120, a shopping apparatus 104, and a plurality of social media platforms 122a-c (collectively 122), which are all communicatively connected over a data network 106.

In one embodiment, the social media platforms 122 comprise online social networking services that allow people to build social networks/relations with others online by posting and commenting on images, videos, etc. For example, the social media platforms 122 may include social media sites such as Facebook®, Snapchat®, Twitter®, Instagram®, YouTube®, Twitch®, and/or the like.

The online sales platform 120, in one embodiment, is a separate system from the social media platforms 122 and allows users to create online sales, as described herein, which are accessible via the social media platforms. For example, a user may create a sale using the online sales platform for selling multiple different products on Facebook®. The user may enter their inventory, prices, shipping information, contact information, and/or the like on the online sales platform 120. After the sale is created, the shopping apparatus 104 assigns an identifier to the sale, which is then used on the social media platform 122 to tie the user's social media post, e.g., live video feed for the sale, to the sale that was previously created at the online sales platform 120.

In this manner, the user's social media post, which may also be assigned an identifier by the social media platform 122, is linked to the user's sale information, e.g., inventory, shopping cart, etc., on the online sales platform 120 using the sales identifier. In one embodiment, the shopping apparatus 104 generates a hash that associates the sale identifier and the social media post identifier and provides the hash as a URL to link the user's sale information with the social media post. In this manner, when a user on the social media platform 122 posts a comment to buy a product featured in the social media post, the shopping apparatus 104 knows which sale the comment is associated with and can therefore update the sales inventory, place the correct item from inventory in the poster's online shopping cart, and/or the like.

FIG. 2 depicts one embodiment of an apparatus 200 for a competitive shopping platform. The apparatus 200 includes one embodiment of a shopping apparatus 104. The shopping apparatus 104, in certain embodiments, includes one or more of a comment module 202, a command module 204, and a cart module 206, which are described in more detail below.

The comment module 202, in one embodiment, is configured to receive one or more comments associated with a social media post on a social media platform 122. As used herein, a social media platform 122 or a social networking service may refer to an online platform that people use to build social networks/relations with other people. Examples of social media platforms 122 may include Facebook®, Instagram®, Twitter®, YouTube®, LinkedIn®, Google+®, Snapchat®, Reddit®, Twitch®, Steemit®, and/or the like.

The social media platforms 122 may allow users to post content and/or to submit comments on posted content. For instance, in certain embodiments, a user may post a live video, a pre-recorded video, an image, a slideshow, a GIF, an audio track, a document, streaming content, and/or the like. Other users who are viewing the social media post may submit comments, messages, chats, likes, votes, emojis, and/or other feedback that are associated with the social media post. In certain embodiments, when a user posts a comment on a social media post, the comment, and consequently the user posting the comment, becomes associated with the social media post. For example, the comment may have a unique identifier assigned to it when the comment is posted, and that unique identifier may be mapped to or otherwise associated with the social media post. In this manner, every comment that is posted for a social media post can be determined, referenced, collected, and/or the like.

In certain embodiments, a user may post content on the social media platform 122 to engage other users in a transaction. For example, a user may post a live video where the user presents and talks about products that the user is selling. Each of the products may be associated with a predefined identifier, e.g., an identifier that uniquely identifies each product presented in the video, such as an alphanumeric string, a number, a word, and/or the like. The identifier that is associated with the product may also be presented during the live video simultaneously with the product so that viewers can see the identifiers that correspond to particular products. Other users on the social media platform 122 who are watching the live video may post comments during the live video to indicate the purchaser's intention to purchase one or more products presented in the live video. For example, if the user presents a coat for sale with the identifier AAA during the live video, viewers may post a comment like “buy AAA,” “purchase AAA,” and/or the like, to indicate that they would like to buy the coat.

In one embodiment, the comment module 202 is part of an online sales platform 120 located on a device that is remote from, separate from, at a different location than, part of a different organization of, and/or the like the social media platform 122. In such an embodiment, the comment module 202 receives comments associated with a social media post from the social media platform 122 using an application programming interface (“API”), and/or the like interface. For example, the comment module 202 may check for new comments associated with the social media post on a periodic basis (e.g., every second, every thirty seconds, every minute, and/or the like) or in real-time (e.g., on a consistent or ongoing basis). In further embodiments, the comment module 202 receives comments from the social media platform 122 after expiration of a predetermined period of time. For example, if the sale associated with the social media post is available for thirty minutes, then the comment module 202 may request the comments for the social media post from the social media platform 122 after thirty minutes.

In certain embodiments, the comment module 202 may register to receive comments for the social media post, and the social media platform 122 may push comments for the social media post to the comment module 202 in real-time when new comments are posted, in a batch at periodic intervals (e.g., every thirty seconds), after expiration of a periodic period of time, in response to a request from the comment module 202, and/or the like. The comment module 202 may receive the comments as a structured or marked-up document, such as an XML document, a JSON file, and/or the like; as a log file or other record; as a table in a database; and/or the like.

The command module 204, in one embodiment, parses each of the one or more comments for commands that indicate that the user who posted the comment would like to purchase a product that was presented in the social media post. For example, the command module 204 may apply one or more regular expressions to the comments to parse out commands from the comments. In certain embodiments, the command module 204 normalizes the comments by making the comments lowercase, removing special characters from the comments, splitting words at whitespaces, and/or the like. For instance, the command module 204 may parse each comment of a comment file, e.g., a structured document file such as an XML file, by converting all the characters of the comment to lowercase, removing special characters, and/or the like to search for specific or predefined purchase commands, or other commands.

The commands, for instance, may include predefined keywords or phrases such as buy (e.g., to purchase an item), sold (e.g., to purchase an item and also let other users know that the product is sold), mine (e.g., to reserve an item), bid (e.g., to place a bid on an item), pre (e.g., to preorder an item), preorder (e.g., to preorder an item), reserve (e.g., to reserve an item), hold (e.g., to reserve an item), sub (e.g., to subscribe to the seller's posts), subscribe (e.g., to subscribe to the seller's posts), follow (e.g., to follow the seller's activity on social media), watch (e.g., to monitor activity for an sale item), remove (e.g., to retract or remove a buy comment), purchase (e.g., to buy an item), donate (e.g., to donate money to a cause highlighted in the seller's post), give (e.g., to donate money or a product), gift (e.g., to provide a one-time or limited number of gifts such as money or products), buy it now (e.g., to automatically purchase an item using the commenter's predefined payment and shipping information without adding the item to a shopping cart), and/or the like. If the command module 204, in certain embodiments, finds comments that do not contain a predefined keyword, then the command module 204 skips, ignores, disregards, or the like the comments that do not contain a predefined keyword.

Otherwise, in one embodiment, if the command module 204 determines that a comment includes a predefined command, such as “buy,” then the command module 204 determines if the following word in the comment is an identifier for a particular product, e.g., “AAA” for the coat above, 111, 1a4, and/or the like. If not, then the command module 204 disregards the comment. Otherwise, in further embodiments, the command module 204 checks the provided identifier against a list of available products for the sale, e.g., an inventory list, to determine whether the provided identifier matches a product in the inventory list. If not, then the command module 204 disregards the comment. In certain embodiments, other parameters may be provided after the product identifier, such as a quantity, a bid price (if the sale is an auction), a size, a color, a model number, and/or the like. For instance, a user may post a comment like “buy 75a qty 2 color red size xl” to specify that the user wants to buy two of product 75a in red and an extra-large size.

In some embodiments, the command module 204 processes administrative commands submitted by the host of the social media post. For instance, if the host wants to dynamically, in real-time, during the sale add a new product to the sale, the host can submit a comment such as “create 747 $100 Large Airplane,” which would create a new product in the user's inventory of a single Large Airplane that cost $100 and has identifier 747. From that point forward, other users may submit comments to purchase the Large Airplane by submitting a purchase comment such as “buy 747.” Other administrative comments may include create, delete (e.g., to delete a product from the sale), sale (e.g., to create a new sale), raise (e.g., to raise the price of an item), free (e.g., to make an item available for sale), lock (e.g., to make an item no longer available for sale), unlock (e.g., to make an item available for sale), and/or the like.

The cart module 206, in one embodiment, automatically creates, generates, populates, and/or the like an online shopping cart at the online sales platform 120 for each of the users who commented on the social media post with a purchase command and an identifier for a product highlighted in the social media post. As used herein, an online shopping chart may refer to a piece of e-commerce software on a web server, e.g., an online sales platform 120 that allows visitors to an Internet site to select and accumulate a list of items for eventual purchase. As described above, users may select products for eventual purchase by commenting on a social media post with the predefined commands and product identifiers.

The cart module 206 may create an online shopping cart for each user who commented on the social media post with a purchase command and a product identifier. Thus, a user may comment on multiple items, or may submit multiple comments for the same item to order multiple quantities of the same item, and after the sale is complete, e.g., after a live video is finished, after a predetermined period of time, after the host takes the sale down, and/or the like, the cart module 206 populates the online shopping cart for the user with the identified products. The user may then review the shopping cart and checkout, e.g., order the products in the cart by providing their shipping and payment information.

In various embodiments, the cart module 206 interfaces with, hooks into, or otherwise integrates with existing online shopping cart platforms such as ecommerce platforms like Amazon®, Shopify®, Magento®, and/or the like to populate the cart and facilitate the purchase of a product. For example, the seller may have an Amazon® marketplace store/shop setup for selling their products on Amazon® or fulfilling their product sales via Amazon®. In such an embodiment, when a purchaser posts a comment that includes a command to purchase an item presented in a social media post, the cart module 206 may populate the purchaser's Amazon® cart, or a shopping cart for a different shopping platform. In some embodiments, the cart module 206 interfaces with an existing online shopping cart platform using an API or other programming interface.

In one embodiment where the cart module 206 interfaces with an ecommerce platform such as Shopify®, when a user posts a comment to purchase an item, such as item 123 using the command “buy item 123”, the item is added to the user's shopping cart at the online sales platform 120. When the sale is complete, or the user is ready to checkout, the cart module 206 may present the user with a link to their shopping cart on Shopify®, which may be populated with item 123. To facilitate the identification of products, quantities, product options, and/or the like between the user's posts on the social media platform 122 and the online sales platform 120, the cart module 206 facilitates communications between the social media platform 122, the online sales platform 120, and Shopify® (or other ecommerce platform).

For instance, when the user posts a command to “buy item 123”, the item may be added to the user's cart on the online sales platform 120. When the sale is complete, the user clicks the link (e.g., a URL) to the Shopify® cart that the cart module 206 presents to view the user's cart and complete the purchase. In response to the user clicking the link, the cart module 206 may send a token to Shopify® as part of the link that identifies the user (e.g., a user identifier) and the sale (e.g., a sale identifier). The cart module 206, located on the Shopify® platform, in response to receiving the token, requests the product information for the products in the user's cart at the online shopping platform 120 (e.g., the items that were automatically added to the user's cart in response to the user posting social media posts to purchase the items).

In such an embodiment, the cart module 206 may be embodied as one or more lines of code (e.g., scripting code (JavaScript), markup code, and/or the like) that are configured to provide functionality to request the user's cart information from the online shopping platform 120. In certain embodiments, in response to the shopping cart information request, the cart module 206 at the online shopping platform 120 provides the product information for the products in the user's shopping cart at the online shopping platform 120 to the Shopify® platform using the Shopify® API, for example.

Thus, when the user clicks the Shopify® link to check-out, the steps described above happen in real-time, seamlessly behind the scenes so that the user is not aware that the online shopping platform 120 is used to facilitate populating the Shopify® shopping cart for the user. In certain embodiments, the foregoing steps may also occur in response to a product being added to the user's cart at the online shopping platform, not solely when the user clicks the link at the end of the sale.

Furthermore, as described in more detail below, a timer may be used to expire items from the user's shopping cart at the online shopping platform 120 and at the ecommerce platform (e.g., Shopify®). For example, when an item is added to the user's cart at the online shopping platform 120, it may only be available in the shopping cart for ten minutes such that if the user does not check-out within ten minutes, then the item is automatically removed from the cart. Consequently, the item will not appear in the user's shopping cart at the ecommerce platform due to the expiration of the timer.

Continuing with the foregoing, in one embodiment, the seller's inventory is not maintained at the online shopping platform 120, but is instead managed at the ecommerce retailer, e.g., Shopify®. In such an embodiment, when the sale starts, the setup module 304, described below, receives an inventory list (which may include product descriptions, available quantities, product identifiers, and/or the like) from the ecommerce retailer using an API for the ecommerce retailer, as a file (such as a spreadsheet, a text file, a binary file, etc.), and/or the like. In addition, when changes are made by the seller to the inventory during the sale, or when products are purchased during the sale, the seller's inventory may also be updated in real-time using the ecommerce retailer's API, or the like.

In one embodiment, instead of, or in addition to, communicating with the ecommerce retailer via an API to check the seller's inventory levels, the setup module 304 at the online shopping platform 120 uses webhooks that come from the ecommerce retailer and that post inventory level updates/changes to the online shopping platform's 120 representational state transfer (“REST”) API. As used herein, a webhook is a method of augmenting or altering how a web page or web application functions using custom callbacks. These callbacks may be maintained, modified, and managed by third-party entities, e.g., ecommerce retailers that may not necessarily be affiliated with the originating website or application, e.g., the online shopping platform 120. By using webhooks, the setup module 305 may not be required to perform a product lookup or inventory check every time products are added to the online shopping cart queue at the online shopping platform 120.

In certain embodiments where the command comprises a command to donate money for a fundraising post, e.g., within a comment posted on a GoFundMe® post, instead of populating a cart with a product (because there may not be any products available for purchase), the cart module 206 interfaces with the fundraising organization facilitating the fundraiser highlighted in the post, and transfers the amount of money specified in the post from the poster's account to the fundraising organization. For instance, a user may post in a comment “donate $100”, “donate one hundred”, or the like. In such an embodiment, the cart module 206 may use the poster's stored payment information that the user normally uses to purchase products to transfer the specified amount to the fundraising organization.

In further embodiments, the shopping apparatus 104 may include one or more bots that monitor donation comments and match the specified donation, or donate some other amount. For instance, the shopping apparatus 104 may collect fees for automatically facilitating transactions between users posting on social media posts to purchase products and the users selling those products. The shopping apparatus 104, however, may monitor when certain commands are posted, such as a “donate” command, and when a “donate” command is given, the bots may automatically post a comment that also includes a “donate” command with a matching amount, or some other amount that may come out of the fees collected from purchase transactions. For example, if a user posts “donate 50” on a fundraising post, a bot may automatically post a comment that also states “donate 50” to match the user's donation.

FIG. 3 depicts one embodiment of an apparatus 300 for a competitive shopping platform. In one embodiment, the apparatus 300 includes an instance of a shopping apparatus 104. The shopping apparatus 104, in certain embodiments, includes a comment module 202, a command module 204, and a cart module 206, which are substantially similar to the comment module 202, the command module 204, and the cart module 206 described above with reference to FIG. 2. In further embodiments, the shopping apparatus 104 includes one or more of a queue module 302, a setup module 304, an immediate purchase module 306, and an influencer module 308, which are described in more detail below.

The queue module 302, in one embodiment, is configured to queue the purchase commands that the command module 204 identifies in a queue on a per-product basis. In other words, the queue module 302 may generate a queue, list, table, or the like for each product presented in the social media post, and may insert purchase commands into the queue of the product that is identified in the purchase command.

In one embodiment, if the sale is a first-come-first-serve type of sale, then the queue module 302 may queue the commands in a chronological order of when the comments were posted on the social media post. In another embodiment, if the sale is an auction-type sale, then the queue module 302 may queue the commands in an order of the bids that are received, e.g., in descending order of the highest bid for a product. In some embodiments, the queue module 302 associates each item in the queue with the user who posted the comment and an identifier for the sale that the product was highlighted in. In certain embodiments, the queue module 302 generates a token comprising a hash of an identifier for the user, e.g., the user's name or credentials, and the sale identifier and stores the token with each item in the queue. In other words, the token may act as an index for each item in the queue.

The setup module 304, in one embodiment, links a social media post that is being used for the sale, e.g., a live video on the social media platform 122, to a sale on the online sales platform 120. In one embodiment, when a sale is created, the setup module 304 creates a unique sale identifier for the sale and links the sale identifier with a unique identifier for the social media post. Furthermore, the setup module 304, in one embodiment, receives an inventory list from the user that specifies the products that are offered for sale in the social media platform 122, the identifiers for the products, the quantities available for each product, and/or the like.

Thus, after a sale has been completed, the setup module 304 generates a link to the online shopping cart for each user that commented on the social media post. The link may be a URL to the online sales platform 120, and more specifically for the particular sale. The link may be provided via a message on the social media platform 122, an email, a text message, an instant message, a push notification, and/or the like to each user who commented on the social media post, to each user who commented with a purchase command on the social media post, and/or the like.

In certain embodiments, when the user clicks on the link and is taken to the online sales platform 120, the cart module 206 may request an identifier for the user such as the user's social media username, credentials, and/or the like, which may have been tokenized when the user clicked on the link using open authorization (“OAuth”), and/or the like. The queue module 302 and/or the cart module 206 may generate a hash of an identifier for the user, e.g., the user's name or credentials, and the sale identifier, which may be part of the URL that the user clicked on, to generate a token, which may be the same token that the queue module 302 generates when adding products to the queue.

The queue module 302 and/or the cart module 206 may use the generated token to identify items in the queues that have the same token. If the identified item in a queue that has a matching token is in a position in the queue that is equal to or less than the current quantity of the product identified by the command in the queue, then the cart module 206 adds the product to the user's shopping cart. For instance, if there are three available products, and the user was the fourth person to submit a comment to purchase the product, which means the user's command would be the fourth item in the queue for the product, then the user would not be allowed to purchase the product because there would not be enough remaining inventory for the first three commenters who want to purchase the product.

The queue module 302 and/or the cart module 206, in certain embodiments, checks each queue for items identified by the generated token for the user, and adds the products identified by the commands in the queues to the user's shopping cart (as long as the inventory quantity limits allow it). The user may then use the automatically generated shopping cart to checkout by providing payment and shipping information. The cart module 302 may also automatically generate an invoice for the seller so that the seller knows who has paid, which products were purchased, and who to send the products to. After products have been purchased, the inventory quantities for the purchased products are updated accordingly (e.g., quantities of products purchases are reduced according to the quantities of the products there were purchased).

In certain embodiments, if a user does not go through with their purchases from the online shopping cart, the queue module 302 removes the items associated with the user from their respective queues after a period of time. In other words, the items expire if they are not purchased after a predetermined period of time. In certain embodiments, the queue module 302 sets a timer for the top item in each queue, e.g., such as ten minutes, an hour, a day, or the like, and if the users associated with the top items for each queue do not purchase the items, then the queue module 302 removes the items from the queues, and the next items becomes the top items in the queues. This may continue until there are no more items in the queues, either because the items were purchased by the associated users or they were not purchased by the associated users and were expired from the queue.

In some embodiments, however, if the sale is still ongoing after the queues have been emptied, and a new comment is made on the social media post, that comment will be processed by the comment module 202 and the command module 204, and the queue module 302 will queue the command when the user clicks on the link to his/her shopping cart. In such an embodiment, when a user visits the social media post for the sale, or clicks a link to the social media post for the sale, the comment module 202 may automatically check the social media post for new comments since the last time the social media post was checked. If there are new comments, the comment module 202 receives them and they are processed and queued as described above.

In this manner, a sale can be conducted using social media that allows users to seamlessly purchase products by simply commenting on a social media post where the products are presented and checking-out using an online shopping cart that is automatically populated with the products that the user commented on. In the background, however, various technically complex steps are performed to link the social media post to the sale generate at the online sales platform 120, transmit the comments from the social media platform 122 to the online sales platform 120, parse the comments for predefined commands and product identifiers, queue the commands on a per-product basis, generate a link to the user's shopping cart at the online sales platform 120, and automatically populate the shopping cart when the user clicks on the link while ensuring the available quantities of the products are checked prior to adding the products to the user's cart and updated after the user has checked out.

The immediate purchase module 306, in one embodiment, is configured to automatically, immediately, and/or the like purchase a product offered for sale in a social media post in response to a comment including a command to buy the product now, e.g., “buy it now”, “buy now”, and/or the like, including the product details, e.g., the product identifier, quantity, size, color, and/or other options. In such an embodiment, the immediate purchase module 306 processes the purchase of the identified item without generating an online shopping cart and/or without presenting the online shopping cart to the purchaser prior to completing the purchase. The immediate purchase module 306, in further embodiments, uses previously stored payment and/or shipping information for the purchaser in order to complete the purchase.

In certain embodiments, the immediate purchase module 306 contacts the purchaser to confirm the user's purchase of the product identified in the comment. For instance, the immediate purchase module 306 may send a text message informing the purchaser of the intended purchase, and may request a response to confirm or reject the purchase, such as a “Yes” or “No” response. Other messages may include emails, push notifications, instant messages, and/or the like. The message may also include the purchaser's payment and shipping information that is on file so that the purchaser can confirm, modify, edit, and/or the like the information.

In some embodiments, the immediate purchase module 306 delays an amount of time before completing the purchase of the product identified in the comment. For instance, the immediate purchase module 306 may send a text message to the purchaser to inform the purchaser of the pending purchase, and that the purchase will be made with the stored payment and shipping information in fifteen minutes unless the purchaser cancels the purchase. The purchaser may then choose to let the purchase be completed at the expiration of the fifteen minutes, provide a response to purchase the product now, or provide a response to cancel the purchase.

In one embodiment, the influencer module 308 is configured to dynamically update an influencer's social presence with a selectable offer that, when selected, automatically populates the user's online shopping cart at the online shopping platform 120 with the products/services in the offer. As used herein, an influencer may be an individual who has the power to affect purchase decisions of others because of his/her authority, knowledge, position or relationship with his/her audience. An influencers social presence may include a webpage, a social media site (e.g., Facebook®, Instagram®), a streaming service (e.g., Twitch®), and/or the like.

In certain embodiments, the influencer's social presence may include space for text, links, graphics, and/or the like that user's may click or otherwise interact with. For instance, Twitch® may allow streamers to place graphics, animations, text, and/or the like on the display while the streamer is playing a video game. As it relates to the subject matter herein, the influencer module 308 may utilize the areas on the display where the influencer can place text, graphics, etc., to display an offer, advertisement, coupon, promotion, and/or the like for products, services, and/or the like that may be related to the influencer and/or the influencer's activities/interests, promoted by the influencer, and/or the like.

For example, a video game streamer on Twitch® may be sponsored by Mountain Dew®. Accordingly, the influencer module 308 may present a link for a buy one, get one free offer for Mountain Dew®. When a user/viewer clicks on the link, the Mountain Dew® products may be automatically added to the user's shopping cart at the online shopping platform 120, and the user may be presented with a link to the online shopping cart (e.g., at the same display location as the originally-clicked link) that the user can select to check-out and receive the offer.

In such an embodiment, the promoter or offer provider may have an account setup at the online shopping platform 120, or at another third-party platform (e.g., Shopify® that the online shopping platform 120 communicates with in order to receive product and inventory information such as available quantities of each product, product descriptions, product identifiers, prices, and/or the like, which the influencer module 308 may use to generate the offers that are presented on the influencer's social presence. In such an embodiment, the influencer module 308 further provides the division of revenue between the influencer and the offer provider based on a predetermined arrangement.

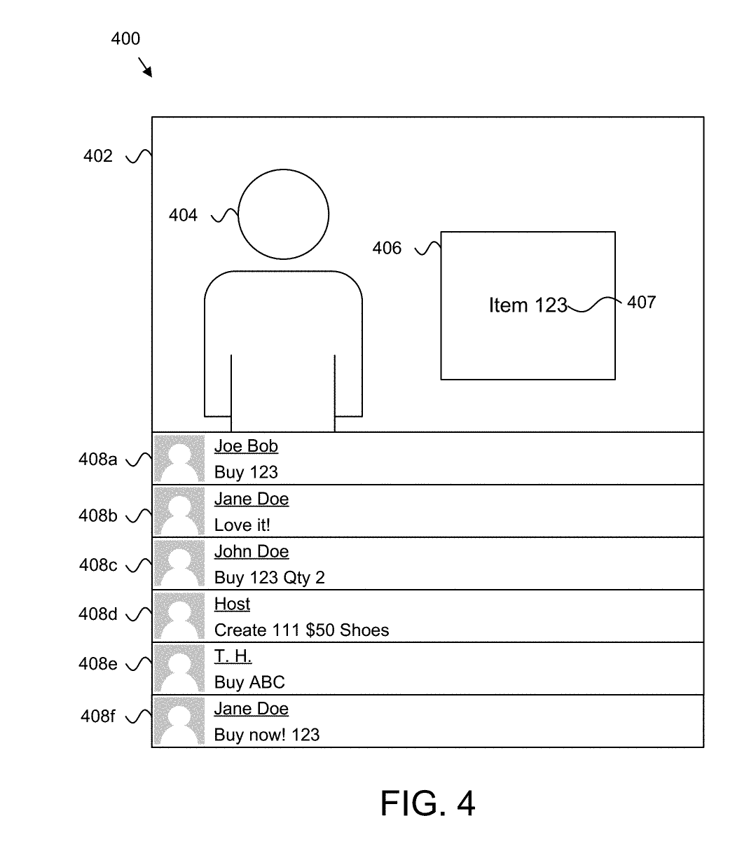

FIG. 4 depicts one embodiment of a social media interface 400 for a competitive shopping platform 120. In one embodiment, the social media interface 400 includes a social media post 402. The social media post 402 may include various content types, such as a live video, as described above, that includes a host user 404 and one or more items 406 that the host user 404 is selling. The one or more items 406 may include an identifier 407, e.g., “123” that is used to identify a particular item.

In one embodiment, social media users who are viewing the social media post 402 can post comments 408a-f (collectively 408) about the social media post 402. Specifically, as described above, the shopping apparatus 104 allows users to include predefined commands in the comments 408 for purchasing items highlighted in the social media post 402.

For example, Joe Bob leaves a comment 408a that states “Buy 123.” In one embodiment, after the comment 408a is posted, the comment module 202 receives the comment at the online sales platform 120 where the command module 204 parses the comment to determine if there are any predefined commands. In this case, the command module 204 recognizes the command “buy” and checks to see if an identifier, such as an inventory number follows the command. The command module 204 parses the term “123” following the command and determines that there is an item in the host's inventory with that identifier. As long as there is enough inventory, the cart module 206 automatically populates an online shopping cart for the user Joe Bob with the item and sends Joe Bob a link to the shopping cart when the sale is over. The cart module 206 may also send a notification to Joe Bob to indicate that the item was added to his cart.

The next comment 408b by Jane Doe states “Love it!”, which does not contain a predefined command. The command module 204 would determine that the comment 408b does not contain a predefined command, and would simply ignore the comment 408b. The following comment 408c by John Doe states “Buy 123 qty 2”. The comment 408c is similar to the previous comment by Joe Bob, however John Doe has specified a quantity of the specified item that he would like to purchase. Accordingly, if there is enough inventory in the host's inventory, the cart module 206 would add two of item “123” to the user's online shopping cart.

In certain embodiments, the host 404 can dynamically add items to the sale during the sale. The host 404, for instance, can post a comment 408d to provide an administrative command such as “Create 111 $50 Shoes” to create a new item for the sale that has an identifier of “111” that cost $50 with a description of “Shoes”. That identifier can now be used in comments 408 by social media users to purchase shoes.

The next comment 408e by T. H. includes another “buy” post, but includes the identifier “ABC”. In one embodiment, if the item is part of the sale, e.g., if the item with identifier ABC has been previously presented, the user T.H. can continue to create comments for it even though it is not the currently highlighted item. Otherwise, if there is not an item with the identifier “ABC”, then the comment will be ignored and nothing will be added to T.H.'s online shopping cart. The command module 204 and/or the cart module 206 may notify T.H. that the item was not found and was not added to his cart.

The final comment 408f by Jane Doe states “buy now! 123” to indicate that Jane Doe would like to immediately purchase item “123” without adding it to an online shopping cart. In such an embodiment, the immediate purchase module 306 may use Jane Doe's payment and shipping information to automatically purchase the item “123”. In certain embodiments, the immediate purchase module 306 sends Jane Doe a message to confirm the immediate purchase using Jane Doe's default payment and shipping information, and may further set a time limit on the immediate purchase such that the item is automatically purchased after the time limit expires if Jane Doe does not respond within the time limit.

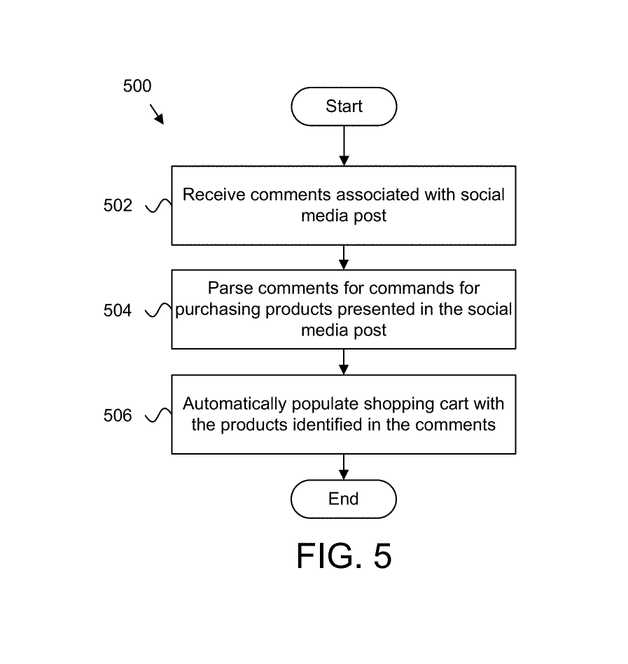

FIG. 5 is a schematic flow chart diagram illustrating one embodiment of a method 500 for a competitive shopping platform. In one embodiment, the method 500 begins and receives 502, at an online sales platform 120, one or more comments associated with a social media post on a social media platform 122. The social media post may be associated with a sale hosted on the online sales platform 120.

In further embodiments, the method 500 parses 504 the one or more comments for commands for purchasing products presented in the social media post for each of one or more users associated with the one or more comments. In certain embodiments, the method 500 automatically populates 506 an online shopping cart at the online sales platform 120 with one or more products identified in the commands for purchasing products for each of the one or more users, and the method 500 ends. In certain embodiments, the comment module 202, the command module 204, and/or the cart module 206 performs the various steps of the method 500.

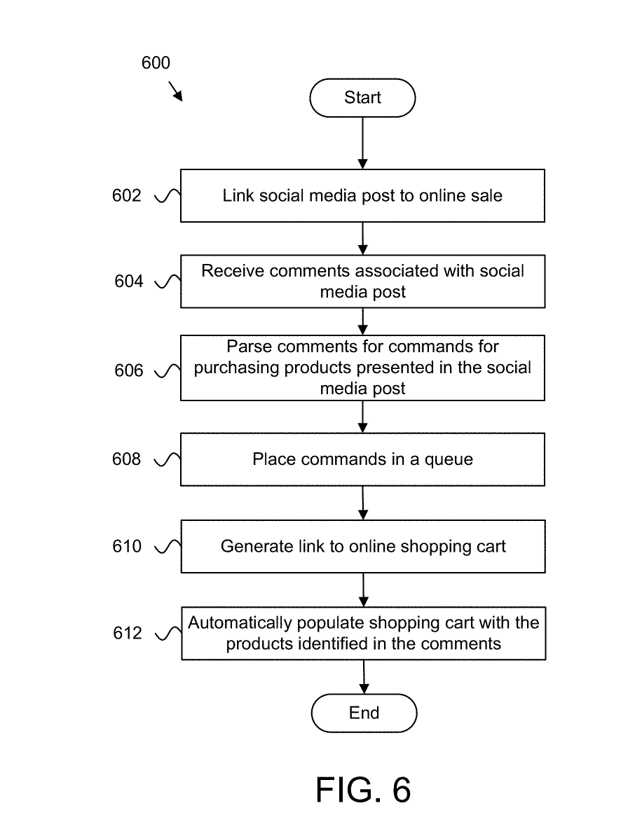

FIG. 6 is a schematic flow chart diagram illustrating an embodiment of another method 600 for a competitive shopping platform. In one embodiment, the method 600 begins and links 602 a social media post to an online sale, e.g., the social media post identifier and the sale identifier are hashed or otherwise associated. In further embodiments, the method 600 receives 604, at an online sales platform 120, one or more comments associated with a social media post on a social media platform 122. The social media post may be associated with a sale hosted on the online sales platform 120.

In various embodiments, the method 600 parses 606 the one or more comments for commands for purchasing products presented in the social media post for each of one or more users associated with the one or more comments. In some embodiments, the method 600 places 608 each of the commands for purchasing a product in a queue on a per-product basis where each item in the queue is indexed by a hash of the sale identifier and the user identifier for the user that submitted the comment.

In certain embodiments, the method 600 generates 610 a link to an online shopping cart that each user who submitted a comment to purchase a product can click on to review their shopping cart and check out. In certain embodiments, the method 600 automatically populates 612 an online shopping cart for the user when the user clicks on the provided link by (1) generating a hash of the user's identifier and the sale identifier to create a token that is used to check the queues for each product available in the sale that the user submitted a purchase command for, (2) checking that the position of an identified item in a queue is equal to or less the available quantity for the product, and (3) adding the product to the user's shopping cart if there is an available quantity, and the method 600 ends. In one embodiment, the comment module 202, the command module 204, the cart module 206, the queue module 302, and the setup module 304 perform the various steps of the method 600.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
receiving, at an online sales platform, one or more comments associated with a social media post on a social media platform, the social media post associated with a sale hosted on the online sales platform;
parsing, for each user associated with each of the one or more comments, the one or more comments to identify commands for purchasing products presented in the social media post; and
automatically, for each of the one or more users, populating an online shopping cart at the online sales platform with one or more products identified in the comments for purchasing products.

2. The method of claim 1, further comprising queuing the purchase commands for one or more products presented in the social media post, wherein purchase commands are added to queues associated with each of the one or more products presented in the social media post based on the products identified in each of the commands.

3. The method of claim 2, further comprising, for each user:
generating a link to the user's online shopping cart associated with the sale;
receiving the user's social media credentials at the online sales platform responsive to the user clicking the link;
generating a token based on a sale identifier and the user's social media credentials;
checking the queue for the user's comments identified by the token; and
adding the products identified in the user's comments in the queue to the online shopping cart.

4. The method of claim 3, wherein a product is added to the user's online shopping cart in response to determining that the position of the token in the queue is equal to or less than a quantity associated with the product.

5. The method of claim 1, further comprising linking the social media post to the sale hosted on the online sales platform, the online sales platform generating the online shopping carts for each user associated with the sale.

6. The method of claim 5, wherein the social media post is linked to the sale hosted on the online sales platform by associating an identifier for the social media post with an identifier for the sale.

7. The method of claim 1, wherein the online sales platform receives the one or more comments associated with the social media post in real-time.

8. The method of claim 1, wherein the online sales platform receives the one or more comments associated with the social media post at periodic intervals.

9. The method of claim 1, wherein the sale is active on the online sales platform for a predetermined period of time.

10. The method of claim 9, wherein the shopping cart for each user is populated with the one or more products after expiration of the predetermined period of time.

11. The method of claim 10, wherein the shopping cart for each user is populated with the one or more products in a same order as the one or more comments are received.

12. The method of claim 10, wherein the sale comprises an auction such that the shopping cart for each user is populated with the one or more products in an order determined based on one or more bids received for each product presented in the social media post.

13. The method of claim 1, further comprising parsing the one or more comments for one or more predefined commands followed directly by an identifier for a product presented in the social media post.

14. The method of claim 1, wherein the one or more comments comprise administrative commands, the administrative commands used to update the sale hosted on the online sales platform during the sale.

15. An apparatus comprising:
a processor;
a memory that stores code executable by the processor to:
receive, at an online sales platform, one or more comments associated with a social media post on a social media platform, the social media post associated with a sale hosted on the online sales platform;
parse, for each user associated with each of the one or more comments, the one or more comments to identify commands for purchasing products presented in the social media post; and
automatically, for each of the one or more users, populate an online shopping cart at the online sales platform with one or more products identified in the comments for purchasing products.

16. The apparatus of claim 15, wherein the code is further executable by the processor to queue the purchase commands for one or more products presented in the social media post, wherein purchase commands are added to queues associated with each of the one or more products presented in the social media post based on the products identified in each of the commands.

17. The apparatus of claim 16, wherein the code is further executable by the processor to, for each user:
generate a link to the user's online shopping cart associated with the sale;
receive the user's social media credentials at the online sales platform responsive to the user clicking the link;
generate a token based on a sale identifier and the user's social media credentials;
check the queue for the user's comments identified by the token; and
add the products identified in the user's comments in the queue to the online shopping cart.

18. The apparatus of claim 17, wherein a product is added to the user's online shopping cart in response to determining that the position of the token in the queue is equal to or less than a quantity associated with the product.

19. The apparatus of claim 15, wherein the code is further executable by the processor to link the social media post to the sale hosted on the online sales platform, the online sales platform generating the online shopping carts for each user associated with the sale.

20. A program product comprising a computer readable storage medium that stores code executable by a processor, the executable code comprising code to perform:
receiving, at an online sales platform, one or more comments associated with a social media post on a social media platform, the social media post associated with a sale hosted on the online sales platform;
parsing, for each user associated with each of the one or more comments, the one or more comments to identify commands for purchasing products presented in the social media post; and
automatically, for each of the one or more users, populating an online shopping cart at the online sales platform with one or more products identified in the comments for purchasing products.
